(19) United States
(12) Patent Application Publication
(10) Pub. No.: US 2014/0032686 A1
(43) Pub. Date: Jan. 30, 2014

(54) SYSTEM AND METHODS FOR A REMOTELY CHANGEABLE NON-VIRTUAL PERSONAL MESSAGE BOARD FOR AN UNKNOWN AUDIENCE

(71) Applicant: Todd Lindsay Wirth, Atlanta, GA (US)

(72) Inventor: Todd Lindsay Wirth, Atlanta, GA (US)

(21) Appl. No.: 13/950,819

(22) Filed: Jul. 25, 2013

Related U.S. Application Data
(60) Provisional application No. 61/675,415, filed on Jul. 25, 2012.

(51) Int. Cl. H04L 12/58

(52) U.S. Cl. CPC H04L 51/00
USPC 709/206

(57) ABSTRACT

The invention is a system for posting personal messages to a display device for an unknown audience, whereby the communicator does not know who will view the personal message. Messages are sent directly to the communicator's display device over a network and are not contained or “housed” in a virtual (server) context. The communicator is able to post a message when not at the device's location by “texting” the device via a variety of possible input devices. The invention displays a new message by replacing the previous message (or as determined by configuration preferences). The invention includes user preferences, security, and low power options. User preferences affect how a message is displayed. Security features protect the system from displaying unauthorized messages. And the low-power option is a dual device configuration wherein the display operates on battery power receiving data from a relay that is powered by an external source.

### CROSS-REFERENCE TO RELATED APPLICATION

This application claims the benefit of U.S. Provisional Patent Application No. 61/675,415, filed on Jul. 25, 2012, entitled “System and Methods for a Remotely Changeable Non-Virtual Personal Message Board for an Unknown Audience,” the disclosure of which is expressly incorporated herein by reference in its entirety.

### BACKGROUND OF THE INVENTION

It is known in the art to provide a traditional message board that allows an individual the opportunity to post a message. The traditional message board may be in the form of a white board with markers or a cork board to which a handwritten note or message can be tacked or otherwise posted. There are numerous known uses for such boards in a variety of circumstances, including in a professional situation such as an office or in a residential situation such as a dorm room. In the usual situation, the user is able to write or post a message either directly on the board or on a piece of paper or “Post-It” note that can be tacked or otherwise secured to the conventional message board.

A personal message board can be of help to an individual who may be away from a given location, and seeks or desires to notify third parties or the general public of relevant information such as, for example, where the individual may be (“In Library”) or when the individual will return to that location (“Back at 1:00 pm”). For example, office workers routinely leave their office or are away from their office for a variety of reasons. The worker may leave for a lunch break or may be away for an extended period of time such as a vacation or a business trip. The office worker may also be away for a brief period due to a meeting or even an emergency. In such situations, it is well known for the worker to post a note on a message board informing the general, unknown public of their intention (e.g., “Back at 1:00 pm” or “Will return to office tomorrow”). Of course, it is also known that circumstances may change. If out to lunch, the office worker may encounter delay and not be able to return to the office at the time stated in the note. If out of the office on a vacation or business trip, the office worker may encounter unforeseen circumstances and not be able to return to the office on a stated day or time. For example, the worker desires to inform unknown persons that he or she will not return “by 1:00 pm.” In such circumstances, the handwritten note and traditional message board are of no help and actually result in an erroneous message. In order to update the handwritten message, the worker must be physically present at the traditional message board. However, as a result of being away from the office, the worker is typically unable to change the message. Should the office worker seek to change or to amend the displayed message, they must return to the office in order to do so. It may not be possible for the office worker to return to the office in order to change the message. Of course, once the worker returns to the office, the point and need are moot.

Moreover, once the stated time has passed, a person seeking to meet with or otherwise engage the office worker is either not assisted by or perhaps even misled by the posted message. For example, if the message board states “Back by 1:00 pm” and it is 2:00 pm, the message is dated and not helpful. In fact, the reader may become needlessly concerned that the message poster is in distress or the reader may think the message poster will be back tomorrow by 1:00 p.m. and not running late today. In other words, once the message has effectively expired or become dated, a member of the public or other third party looking to meet with or otherwise engage the office worker is left to wonder as to the person's circumstances and whereabouts. The communication, if any, can be very inefficient.

In today's electronically connected environment, many users are accustomed to using email or text messaging to send messages. However, such mechanisms are designed and generally effective on a known user basis. In other words, the message is typically sent to a known person or group of known persons whose electronic mail address or addresses, or telephone number or telephone numbers, are known to the message poster. Communication in such instances is direct between the office worker and the known person or persons who are seeking to engage the office worker. Thus, it is to be understood that an unknown audience also exists, in that the audience for a communication is not necessarily known to the communicating party. Thus, an unknown audience refers to circumstances where the communicating or message posting party does not know who is viewing or consuming the personal message. That does not mean that the communicating or posting party is not acquainted with or in some way knows one or more persons who may consume or view a message. For example, presume that Donna from the Accounting Department stops by the communicating party's office and views a posted message to the effect that the communicating party will be out of the office until 3 p.m. The communicating party is certainly acquainted with Donna, but the communicating party did not know that Donna would be the recipient of the posted message, as her visit regarding a hypothetical expense report matter was unannounced and unexpected. Hence, the audience for the personal “out of office until 3 p.m.” message was unknown, but that does not mean that the communicating party did not “know” Donna. It is possible that an unknown audience could be comprised of multiple acquaintances or people wholly unknown to the communicating party, or both.

Thus, there is potential in the art for an efficient message board system and method of use that allows a user to first post a message and then be able to update the message displayed remotely so as to ensure that the message is current and helpful to an unknown audience of people who may be looking to engage or otherwise contact the user. The device would preferably not be limited to a certain protocol, but would rather be able to employ multiple protocols such as Short Message Service text messaging, electronic mail, and other known protocols that allow for remote communication.

### SUMMARY OF INVENTION

The present invention provides a system and methods for remotely changeable, non-virtual personal message board for an unknown audience that is capable of displaying user messages. The system includes an input device and a display device whereby a user can remotely change or alter a displayed message. Various input devices and display devices may be used in accordance with the disclosed invention. Input device(s) and display device(s) are interconnected by a network or network device that allows for communication there-between, including remote communication such that a user need not be physically present with the display device.

In a preferred form, a system according to the present invention may comprise a display device which includes a display screen suitable for mounting on a door, wall, desk or any like location where it can be viewed by any person passing by the display. Furthermore, the invention includes an input device for transmitting a message for display on the display screen. In use, a user can change the display by sending messages via manipulation of the user input device. Thus, the display device must be capable of accepting input from a large number of sources and is capable of receiving such input via a network or network device depending upon the desired use of the system.

In another preferred form, a device according to the present invention may comprise an input device, a communications link, and a display device. The communications link may take any suitable form that can relay data wirelessly to the display screen such as a low power FM, Bluetooth, or Wi-Fi transmitter, or any other suitable RF technology. The communications link would transmit a signal that would then be received by an antenna (attached to the display device) or other appropriate receiver technology where it could be received by the display device. Such an arrangement would enjoy the benefit of allowing the display device to operate at low power which may allow the display device to be positioned distantly from a power source. In such system the link device would nominally be connected to a power supply (wall power) while the display device would operate nominally on battery power. The relay, in effect, reduces the amount of power necessary for operation of the display device.

Thus, it is an object of the present invention to provide a system or device whereby a user can send a message (via an input device) from any location to the display device. More specifically, the message of the present invention may be updated at proximity or at a remote location miles apart. Such updating is the basis for sending messages and location of the user therefore is not a factor. It is desirable for a display device in accordance with the present invention to be placed in a readily viewable position so that it may be seen by anyone passing by the display. Thus, an input device can access the display device by any suitable means, including a variety of input devices such as a wireless “smart” phone, a computer, or any device that facilitates appropriate communication with the display device. It is to be understood that no specific input device is necessarily assumed for practice of the present invention. It is to be further understood that the present invention may include a relay that allows for low power consumption by the display. The relay, or communications link, may include a device that translates incoming text messages into a protocol suitable for processing by the display. The relay may be positioned within the system between the input device and the display device so as to facilitate communication with the display device. In such a system, the display is fitted with a receiver suitable for receiving wireless communication from the relay.

The person of ordinary skill will appreciate that the system is designed for both public and private network configurations. Thus the system can operate with devices on a public network utilizing registered public addresses or on a private subnetwork. Public networks refer to publicly available infrastructure such as mobile networks or land based networks i.e. the Internet where a device is addressable within that context. In contrast, a private subnetwork refers to any network that is connected to a public network (either directly or indirectly) but not addressable within the public context. Again in such situations where the device is connected to a private network, a publicly available proxy server (running one or more routing services as a host) may be used to service the display devices in the system.

The person of ordinary skill will further appreciate that a message is displayed on the display device in accordance with the display's feature set. For example, in lieu of showing a single message, the display may list messages sequentially (showing previous messages). Alternately, the display's feature set may allow for slogans or banners in addition to regular messages. Also the feature set may allow for changing the font, style, or color of the displayed message or may allow any combination thereof and other features not described herein.

Further objects, features, and advantages of the present invention will become apparent to those skilled in the art from reading of the following description, a review of the accompanying drawings and the appended claims.

### BRIEF DESCRIPTION OF THE DRAWINGS

FIG. 1 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 2 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 3 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 4 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 5 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 6 is a schematic diagram illustrating an embodiment of the disclosed invention showing various exemplary physical components of a remotely changeable, non-virtual personal message system for an unknown audience that is able to be remotely manipulated by a user to change the message or add an additional message to be displayed by the display device.

FIG. 7 is a flow chart representing a method performed in accordance with the present invention of a remotely changeable, non-virtual personal message system for an unknown audience.

### DETAILED DESCRIPTION

The following detailed description is to be read in conjunction with the appended drawing figures in which like numerals indicate like parts throughout the several views.

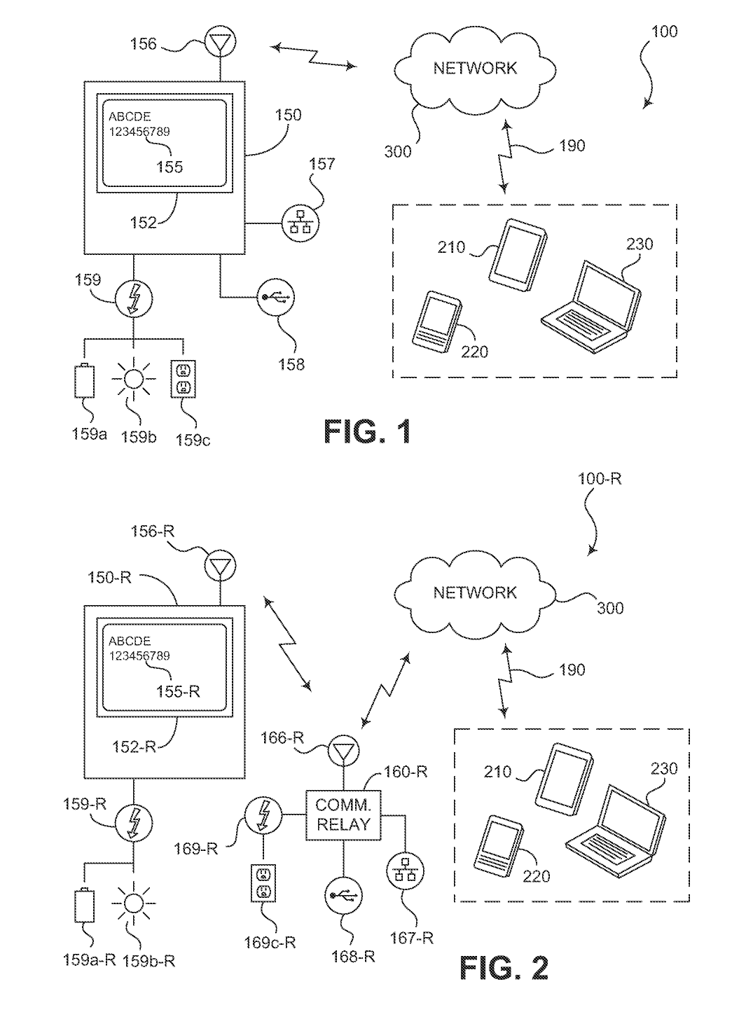

FIG. 1 shows an embodiment of a remotely changeable, non-virtual personal message board for an unknown audience according to the present invention at 100. This includes a display device 150 characterized by a display screen 152. The display device 150 is able to display desired alphanumeric and/or graphical information, shown generally at 155 (e.g., ABCDE 1234567). It will be appreciated that display devices as shown at 150 in the several views are provided in various sizes, resolutions and are well known in the art. The present invention is able to use all such devices so long as the other attributes of the invention as described herein are present. The display device 150 can be mounted for viewing by the public in any number of ways. For example, the display panel 150 may be placed on a desk or like horizontal surface (not shown), mounted on a wall or a door or some other vertical surface, or displayed in essentially any other position so long as members of the public or any other intended viewer or viewing audience can see the display screen 152. Moreover, it is known to provide display panels 150 having various viewing angles such that a viewer need not be directly in front of the screen 152 in order to read the indicia 155. Thus, the display panel 150 may contain various sign elements such as LCDs, LEDs, mechanical shutters and any other suitable display element technologies suitable under the circumstances such that a viewer may be able to read a message or other information on the display screen 152 from a variety of angles. The display device also includes various communications and networking technologies. The inclusion of such technologies are optional except to the extent that one of the technologies is necessarily utilized in order to receive incoming messages. It has been contemplated that such devices may include a wireless receiver 156, an Ethernet port 157, or a USB port 158. It has further been contemplated that the technologies, specifically the USB port 158, may be used for other non-network communications including with peripheral devices such as keyboards, personal computers, or smart phones. In such cases the non-network communications device can be used for updating firmware, configuring preferences, or directly entering messages to the display. The display device is electrically powered, as shown generally at 159. The provision of such electrical power may be accomplished in various ways, including but not limited to: battery 159a, solar panel 159b, or socket receptacle 159c, for example. The details of such power and associated devices are well known to the person of ordinary skill in the art. Moreover, as described below, the invention contemplates certain devices that are able to allow the display device 150 to operate on a reduced power consumption basis, particularly in the event that a battery 159a is utilized. The display 150 may be connected to a network, including input devices, as shown generally at 190 in FIG. 1 and FIG. 2, and described in greater detail below.

FIG. 2 shows an alternate embodiment of the remotely changeable, non-virtual personal message board for an unknown audience generally at 100. This embodiment includes a communications relay 160-R. This embodiment further includes a display device 150-R characterized by a display screen 152-R. The display device 150-R is able to display desired alphanumeric and/or graphical information, shown generally at 155-R (e.g., ABCDE 123456789). It will be appreciated that display device shown at 150-R in FIG. 2 may be provided in various sizes, resolutions and are well known in the art. The present invention is able to use all such devices so long as the other attributes of the invention as described herein are present. As with the display device shown in other figures at 150, the display device 150-R can be mounted for viewing by the public in any number of ways. For example, the display panel 150-R may be placed on a desk or like horizontal surface (not shown), mounted on a wall or a door or some other vertical surface, or displayed in essentially any other position so long as members of the public or another intended viewer can see the display screen 152-R. Moreover, it is known to provide display panels 150-R having various viewing angles such that a viewer need not be directly in front of the screen 152-R in order to read the indicia 155-R. Thus, the display panel 150-R may contain various sign elements such as LCDs, LEDs, mechanical shutters and any other suitable display element technologies suitable under the circumstances such that a viewer may be able to read a message or other information on the display screen 152-R from a variety of angles. The display also includes a wireless receiver 156-R that receives incoming data from a communications relay 160-R. The communications relay 160-R is intended to separate out components that rely on physical locality such as power receptacles or communications ports (e.g., items that require a corded connection), hence the display device 150-R may be provided without ports as described with reference to the embodiment shown in FIG. 1 and other drawing figures. In accordance with the present invention, the relay 160-R is fitted with a wireless transmitter 166-R, an Ethernet port 167-R, and/or a USB port 168-R. As with the embodiment shown in FIG. 1, the USB port 168-R may be used for other non-network communications devices such as keyboards, personal computers, or smart phones. In such cases the non-network communications device can be used for updating firmware, configuring preferences, or directly entering messages to the display (via the relay). Both the display device 150-R and relay 160-R are electrically powered, as shown at 159-R and 169-R respectively. The display device 150-R may derive power from either a battery 159a-R or a solar panel 159b-R for example. The relay device will obtain power from either a socket receptacle 169c-R or from its USB port 168-R. The details of such power devices are well known to the person of ordinary skill in the art. Moreover, as described below, the invention contemplates certain devices that are able to allow the display device 150-R to operate on a reduced power consumption basis.

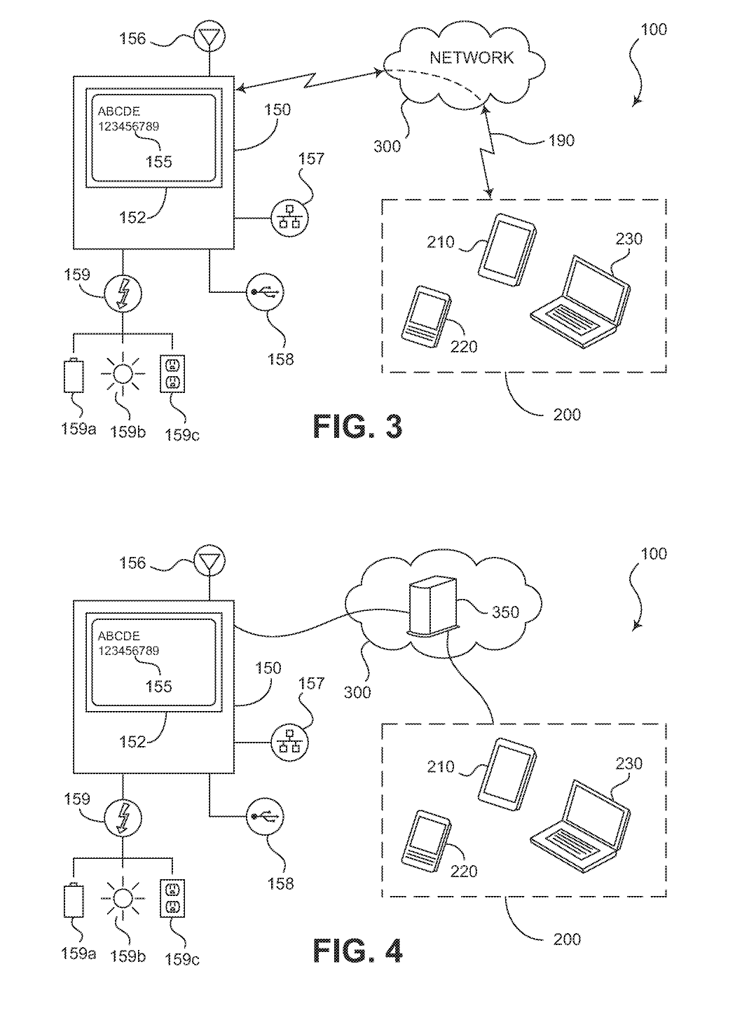

FIG. 3 shows an embodiment of the present invention which includes user input devices, shown generally at 200, for transmitting data by a user to the display device. In other words, the user input devices 200 may be a touch pad device 210, or a smart phone 220, or a personal computer 230 or other input device that can transmit messages over a network 300. For example, while the input device 200 may comprise a smart phone which the user would type a message and send it, the input device could also include a regular landline phone that, in conjunction with voice recognition software (and hardware necessary to run such software), allowed the user to create a message by speaking rather than typing or some other input. By way of illustration and not limitation, the user input devices 200 may be capable of communicating via the network 300 using any of the known messaging protocols such as short message service protocol (SMS), simple mail transfer protocol (SMTP), TELNET, file transfer protocol (FTP), hyper-text transfer protocol (HTTP), or even proprietary protocols designed for such use.

A preferred embodiment of the present invention further includes a network, shown generally in drawings at 300. The ability to communicate (for example, via Voice Over Internet Protocol or “VOIP”) and browse the Internet is well known. Thus, in a preferred aspect, the network 300 contemplated by the invention may be the Internet. However, the invention may be practiced using other technology, such as the public switched telephone network (not shown). The purpose of the network 300 is to facilitate communication between a user interface device 200 and a display device 150. The person of ordinary skill will appreciate that the display device 150 shown in FIG. 3 could also be a display device 150-R including a relay 160R. Any network 300 that permits such communication is suitable for practice of the present invention.

FIG. 4 shows an embodiment of the present invention adapted for use with private networks. In such a system the user input devices, shown generally at 200 (including the touch pad device 210, the smart phone 220 and the computer 230), are used to transmit messages via a network 300, whereby said message arrives at a server 350 for routing to the end display device 150. Once again, the person of ordinary skill in the art will appreciate that the display device 150-R may be utilized in place of or in addition to the display device 150. In the system 100 shown in FIG. 4, a display device 150 (or 150-R) will periodically provide location information (which may conveniently be in the form of an internet address) to the server 350. The server 350 will host one or more routing services which will record the location of each device on the network. The person of ordinary skill will further appreciate that the system 100 may incorporate multiple display devices 150 (or, as explained above, 150-R) such that a user may post original and update messages remotely as contemplated by the invention. Further, and by way of example, a display device 150 or 150-R may be located in an office environment (having multiple display devices) provided with a network that is not, in the conventional sense, publicly available (e.g., behind a firewall), using the exemplar IP address 192.168.0.1. In such a case, the device 150 may be configured to connect to the server 350 to periodically fetch messages that are staged for routing. In this example, the connection itself provides the location information such that the server 350 can transmit messages for display at 155 on the display devices 150 (or 150-R). A user may have need of multiple displays 150 (or 150-R) and, virtue of a system 100 that provides multiple displays, a user may use an input device 200 to send messages via the network 300 to such multiple personal displays. It is to be further appreciated that, by varying the configuration, it would be possible to allow a single user to post different messages at displays at different locations. For example, different display devices 150 or 150-R could be provided with differing IP addresses (and still be behind any firewall). It is understood that the details of such configurations are within the purview of the person of ordinary skill in the art.

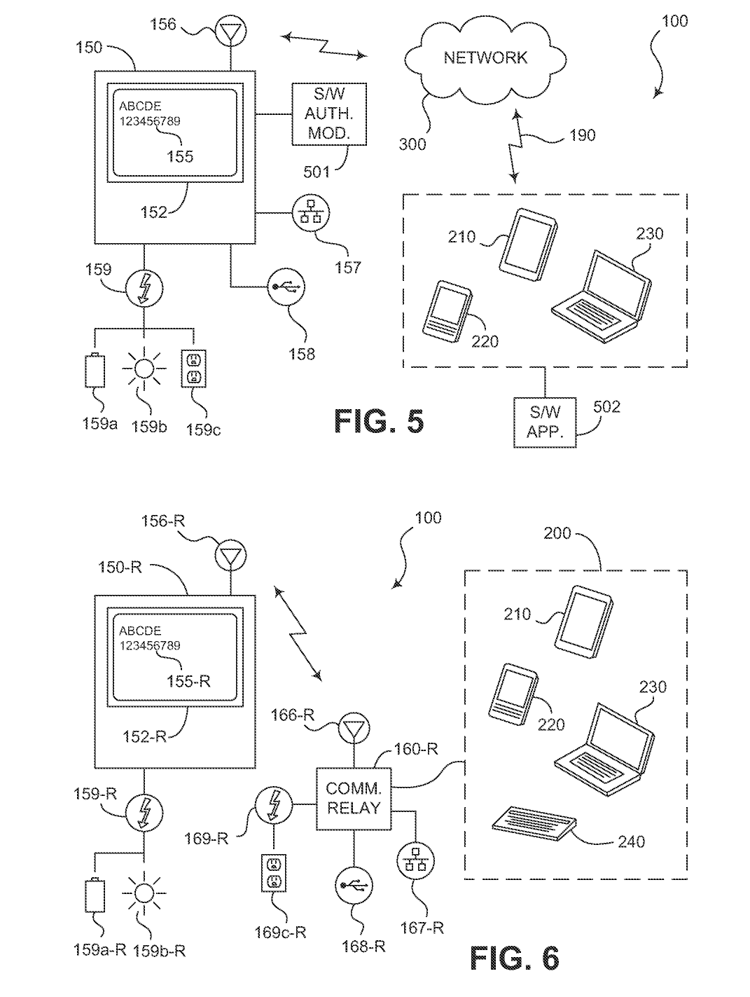

FIG. 5 shows an embodiment of the system where a software authentication module 501 has been added to ensure that only authorized users can submit messages to the display system 100 (or 100-R). In such a system 100, the user input devices, shown generally at 200, are used in conjunction with a software application 502 that is designed to encrypt, protect, or otherwise obfuscate the message that is sent via the network 300 and received at the display system 100 (or 100-R) and then decrypted and validated by authentication module 501. For example a smart-phone 220 employed by a user may include an application specifically crafted for use with the display device 150 (or 150-R), depending on the embodiment) which performs public-key encryption. Such application 502 will encrypt data with the public key, which the user obtains during system 100 setup, then the input device 220 transmits the encrypted data over the network 300 using the software application 502. Upon being received by the display device 150 (or possibly 150-R depending on the embodiment), the authentication module 501 decrypts the data using its private key, and then validates the message prior to displaying it. The authentication module 501 could be utilized with the relay 160R or, as shown in FIG. 5, with the display device 150 (or 150-R). A validation mechanism can be anything from a personal code or password, or could utilize digital signing techniques. Such methods are well known in the art, and it is recognized that, in either case, the method utilized can be verified to a degree of certainty such that only an authorized user sent the message. It is to be appreciated that as a result of such authentication and validation, the user may be able to use differing input devices as necessary to update a message or otherwise send a message because the user can input the personal code or password from any input device.

FIG. 6 shows an embodiment of the system where the user interacts directly (without an intervening network) with the display system using one of the user input devices 200. Such interaction may be a part of facilitating setup of the system 100 to adjust configuration parameters and to potentially directly load messages on to the display. (Note: This is an example of why direct interaction might be used. Facilitating set up of the system 100 or 100-R in FIG. 1 and FIG. 2 to adjust configuration parameters could conceivably be done remotely as well.) In this direct interaction situation depicted in FIG. 6, the user may plug-in to the display device via the USB port 168-R using either a touch pad 210, smart-phone 220, laptop (or pc) computer 230, or a keyboard 240. In any case, the display system 100 will be configured to detect the selected input device and take the appropriate action, as is known in the art. As shown in FIG. 6, a direct connection can be made between an input unit 200 and the relay 160-R. However, the person of ordinary skill will appreciate that the connection can also be made between an input unit 200 and the display device 150 or 150-R (via 160-R).

Thus, in use of a preferred embodiment of the present invention, the present system 100 may be initialized by use of a computer 230 that interacts directly with the preferred embodiment 100, including a display device 150 or 150-R (via 160-R) to set appropriate parameters and preferences. The connection between the computer 230 and the display device 150 or 150-R (via 160-R) may be by a conventional USB cable or the like. Once initialized, a user may utilize any of a number of input devices such as a tablet 210, a smart phone 220 or a computer 230 to communicate with the display device 150 or 150-R (via 160-R). For example, once connected, the user may be provided with a menu of display options, including but not limited to a default message. Upon selecting this option, the user inputs a message to be displayed on the display device 150 or 150-R, which is then displayed as intended (see 155 or 155-R) on said display.

Upon initial configuration, the display device 150 (or 150-R) may be accessed by remote input devices 200 such as the cell phone 220 or laptop computer 230. The user inputs a desired message using the input device 200 to be displayed as a text message (or other protocol) and transmits to the display device 150 (or 150-R). Once received, the message 155 (or 155-R) is displayed in accordance with the user preferences stored during initial setup. In this way, the user has the ability to remotely change or update the message displayed without having to be physically present at the location of the display device 150 or 150-R.

Again, the displayed message 155 is now viewable by an audience, personally known or not, such that the user has transmitted the message 155 to an unknown audience.

The display devices 150 and 150-R described above may include a processing device, such as a general-purpose or specific-purpose processor or microcontroller for controlling the operations and functions of the display device 150. In some implementations, the processing device may include a plurality of processors for performing different functions.

The display devices 150 and 150-R described above may also include memory, such as internally fixed storage units, removable storage units, and/or remotely accessible storage units, each including a tangible storage medium. The various storage units may include any combination of volatile memory and non-volatile memory. For example, volatile memory may comprise random access memory (RAM), dynamic RAM (DRAM), etc. Non-volatile memory may comprise read only memory (ROM), electrically erasable programmable ROM (EEPROM), flash memory, etc. The storage units may be configured to store any combination of information, data, instructions, software code, etc.

The display devices 150 and 150-R described above may include one or more processors and/or may include other components for executing various operations of the display devices. These functional components may be implemented in hardware, software, firmware, or any combinations thereof. Also, the software authentication module 501 may be implemented in software or firmware that is stored on a memory device and that is executable by a suitable instruction execution system. In various implementations of the invention, logical instructions, commands, and/or code can be implemented in software, firmware, or both, and stored in memory. In this respect, the logic code may be implemented as one or more computer programs that can be executed by a processing device. In some implementations, logical instructions, commands, and/or code can be implemented in hardware and incorporated in the processing device using discrete logic circuitry, an application specific integrated circuit (ASIC), a programmable gate array (PGA), a field programmable gate array (FPGA), etc., or any combination thereof. In some implementations, logical instructions, commands, and/or code can be implemented in both hardware and software/firmware.

The input devices 200 are used to enter personal messages. The input devices may be configured to run specialized software for this purpose or may use default functionality (i.e., text messaging on a smartphone.) These messages are displayed on the display screen 152 of the display device 150. The input devices 200 are also configured to enable the users to send messages to the display system. When messages are sent, the display device 150, 150-R may be configured to display these messages in a number of ways. For example, the display device 150 may display a history of all authenticated messages received. The messages may be arranged chronologically and/or arranged in any other suitable configuration as specified by the user's configuration parameters.

The user preferences may include any number of characteristics. The user preferences may be saved in the display device 150, relay 160R, or other suitable storage device within the system 100. For example, the user preferences may include information regarding the manner in which the personal messages are displayed, such as font, font size, font color, date and time information, times, and other suitable characteristics as would be known to one of ordinary skill in the art.

According to various implementations of the present invention, the display device 150, 150-R may display the one or more messages on the display screen 152 continually. In other embodiments, the display screen 152 may display messages only when a person is present in the vicinity of the display device. To view the display, a person may press a button or key to activate the display. The display on demand technique may be desirable for display devices that are battery powered and/or display devices that are viewed infrequently.

Also, the messages may be displayed for a duration of a certain time period, such as for one day, one week, two weeks, one month, etc. The messages may be displayed chronologically where more recent messages are displayed nearer to the top of the display screen 152. Older messages may be scrolled downward and off the screen when a certain number and size of newer messages are displayed. The display device may include scroll buttons to allow a viewing person to scroll down to older messages if desired. In some embodiments, the size of the text may be reduced if a certain message capacity is exceeded.

According to some implementations of the present invention, new messages may be highlighted in a number of ways to indicate to possible viewers that a new message has been posted. The option to post a new message as a special alert or emergency may be chosen by the user, either using a specific entry method on the input devices 200 or according to user preferences. Alerts, emergencies, new messages, and other types of special messages may be distinguished from regular message by various types of display techniques, such as flashing text, a bright text color, a brighter illumination, a bolded font, underlining, special borders, etc.

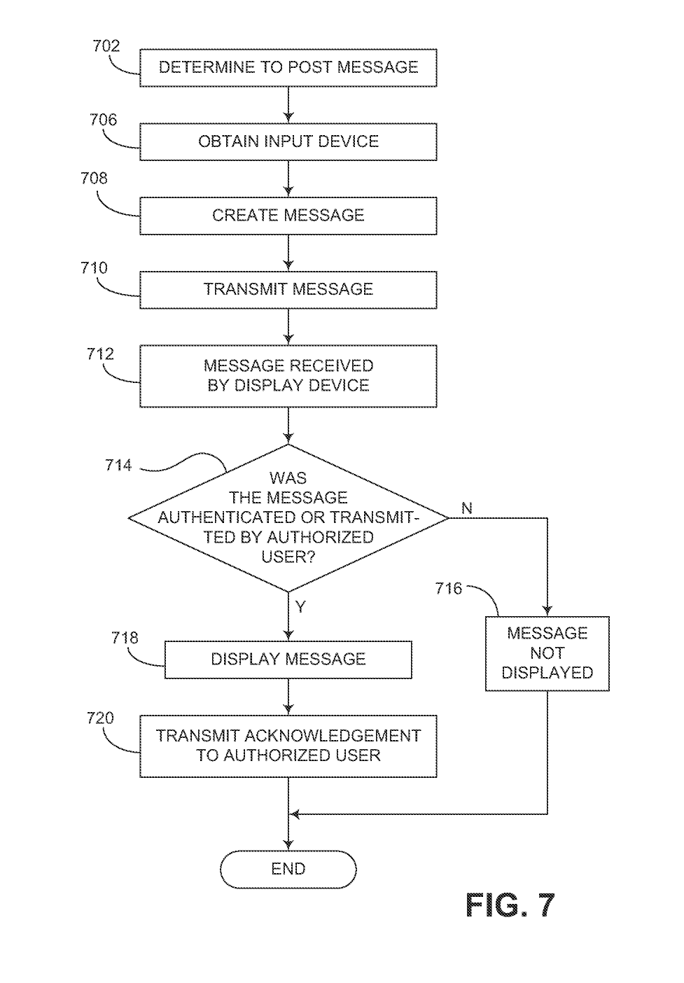

FIG. 7 is a flow diagram showing an embodiment of a method for posting personal messages to the remotely changeable personal message board. Block 702 indicates that a user determines to send a message. The actions of blocks 702 may include initiating a software program on an input device that allows a user to electronically and remotely post a message on the personal message board. The input device may include one or more of the input devices 200 described with respect to FIGS. 1-6. When the user decides to post a message, the method proceeds to block 706, which indicates that the user obtain a suitable input device for posting the message. The user then creates a new message as indicated in block 708.

When the message has been entered, the input device is configured to transmit the message, as indicated in block 710. The message may be transmitted, for example, to a display device, which may include one or more of the display devices 150, 150-R described with respect to FIGS. 1-6. As indicated in block 712, the display device is configured to receive the message. According to decision block 714, the display system is configured to check the message to determine whether or not the message is authenticated. In other words, it is determined whether the message was transmitted by an authorized user.

If it is determined in block 714 that the message is not authorized, the method branches to block 716, which indicates that the message is not displayed and the method ends. If the message is determined to be authorized, the method proceeds to block 718, which indicates that the message is displayed. For example, the message may be displayed on a display screen of the display device. In addition, when the message is displayed, the method may also include transmitting an acknowledgement to the authorized user or authorized input device. The acknowledgement may include information that the message was authorized and/or that the message was displayed. After the message is displayed and acknowledgement is transmitted, the method ends. The method could conceivably end after block 718.

According to some implementations, the flow diagram of FIG. 7 may show the architecture, functionality, and operation of possible implementations of software or firmware stored on the display device 150, 150-R and/or input devices 200. In this regard, each block may represent a module, segment, portion of code, etc., which comprises one or more executable instructions for performing the specified logical functions. It should be noted that the functions described with respect to the blocks may occur in a different order than shown. For example, two or more blocks may be executed substantially concurrently, in a reverse order, or in any other sequence depending on the particular functionality involved.

It should be emphasized that the above-described embodiments are merely examples of possible implementations. Many variations and modifications may be made to the above-described embodiments without departing from the principles of the present disclosure. All such modifications and variations are intended to be included herein within the spirit and scope of the present disclosure and protected by the following claims.

What is claimed is:

1. A remotely changeable, non-virtual personal message board comprising:
a display device capable of receiving and displaying at least one message for an unknown audience; and
an input device in connection with said display device that is capable of remotely changing said message.

2. The remotely changeable, non-virtual personal message board of claim 1 wherein said input device is connected with said display device by means of a network.

3. The remotely changeable, non-virtual personal message board of claim 1 further including an electronic relay capable of receiving messages and retransmitting messages over a short wireless distance and said display device is capable of receiving short distance wireless transmissions of data, such that a message can be delivered to said display device via the network and relay via an implied wireless network.

4. The remotely changeable, non-virtual personal message board of claim 3 wherein said relay is directly addressable on a network.

5. The remotely changeable, non-virtual personal message board of claim 3 wherein said display device is capable of storing user preferences.

6. The remotely changeable, non-virtual personal message board of claim 3 wherein said relay is capable of storing user preferences.

7. The remotely changeable, non-virtual personal message board of claim 5 wherein said display device authenticates incoming data in accordance with the stored user preferences.

8. The remotely changeable, non-virtual personal message board of claim 6 wherein said relay authenticates incoming data in accordance with the stored user preferences.

9. A non-virtual, remotely changeable display device capable of receiving at least one text message and displaying said at least one text message to an unknown audience.

10. The display device of claim 9 wherein said display device is directly addressable on a network.

11. The display device of claim 9 wherein said display device is capable of storing user preferences.

12. The display device of claim 11 wherein said display device is capable of displaying said message in accordance with said stored user preferences.

13. A remotely changeable, non-virtual personal message board comprising:
a display device capable of receiving and displaying at least one message for an unknown audience;
an input device in connection with said display device that is capable of remotely changing said message, said connection including a server system that routes said at least one message from said input device to said display device.

14. The remotely changeable, non-virtual personal message board of claim 13 wherein said server system is capable of storing user preferences.

15. The remotely changeable, non-virtual personal message board of claim 14 wherein said server system is coupled to said display and routes said at least one message to said display via a network.

16. The remotely changeable, non-virtual personal message board of claim 14 wherein said display device is configured to periodically relay said user preferences to said server system so that a said at least one message can be displayed in accordance with said preferences.

17. The remotely changeable, non-virtual personal message board of claim 16 wherein said input device can be used by a user to update said at least one message as displayed on said display device such that an updated message can be displayed on said display device.

18. The remotely changeable, non-virtual personal message board of claim 17 wherein said server is capable of authenticating incoming messages in accordance with said stored user preferences and routes only those messages that are authenticated in accordance therewith.

19. The remotely changeable, non-virtual personal message board of claim 17 further including an electronic relay capable of receiving messages and retransmitting messages over a short wireless distance and said display device is capable of receiving short distance wireless transmissions of data, such that a message can be delivered to said display device via the network and relay via an implied wireless network.

20. The remotely changeable, non-virtual personal message board of claim 19 wherein said relay is directly addressable on a network.

21. The remotely changeable, non-virtual personal message board of claim 19 wherein said display device is capable of storing user preferences.

22. The remotely changeable, non-virtual personal message board of claim 19 wherein said relay is capable of storing user preferences.

23. The remotely changeable, non-virtual personal message board of claim 21 wherein said display device authenticates incoming data in accordance with the stored user preferences.

24. The remotely changeable, non-virtual personal message board of claim 22 wherein said relay authenticates incoming data in accordance with the stored user preferences.

25. A method for displaying a message that can be updated to an unknown audience, said method comprising:
providing an electronic message board in a position to be viewed by at least one member of an unknown audience,
inputting a message to said electronic message board using an input device connected to a network, and
displaying said message on said electronic message board such that at least one member of said unknown audience can view said message.

26. The method of claim 25 further comprising alerting a user that the message has been displayed on said personal message board.

27. The method of claim 25 further comprising inputting an updated message to said electronic message board wherein said original may be updated by said updated message and displayed on said electronic message board.

28. The method of claim 25 further comprising authenticating said electronic message such that said message will be displayed on said electronic message board only if it is authorized.

29. The method of claim 27 further comprising authenticating said updated message such that said updated message will be displayed on said electronic message board only if it is authorized.

30. The method of claim 27 for the comprising alerting a user that the updated message has been displayed on said personal message board.
